(19) United States
(12) Patent Application Publication
(10) Pub. No.: US 2009/0094096 A1
(43) Pub. Date: Apr. 9, 2009

(54) INTERACTIVE ADVERTISEMENT FRAMEWORK

(75) Inventors: Soren Riise, Cupertino, CA (US); Vincent Frederick Chew, Burlingame, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/869,612

(22) Filed: Oct. 9, 2007

(51) Int. Cl. G06Q 30/00; G06F 17/30; G06F 17/40

(52) U.S. Cl. 705/10; 705/14

(57) ABSTRACT

A system including a server is configured to enable a user of a client device to view advertisements. The system may provide an advertisement framework to be displayed on the client device, the framework including an advertisement and a set of controls. The controls may allow a user to view another advertisement, view a previously viewed advertisement, or submit information to a server. Advertisements may include forms, coupons, or other types of advertisements. The framework may be displayed in response to a user selection or mouse-over of an initial advertisement, and the framework may be larger than the initial advertisement. The system may determine advertisements to be sent to the client device based on a number of factors, including user demographics, information entered in any of the advertisement forms, user manipulation of the controls, or other factors.

### TECHNICAL BACKGROUND

The present invention relates generally to advertising, and more particularly but not exclusively to presenting multiple advertising content to a user.

The explosive growth of the Internet in recent years has been accompanied by a tremendous increase in the amount of advertising on the Internet. Web pages, streaming video, and other content transmitted across the Internet often have advertising and marketing content embedded or associated with it for reception by end users. Web pages often include one or more advertisements competing with each other for space and viewing time by the user. Limited space on a web page may limit the amount of advertising revenue a web site can generate.

A banner ad is one type of advertisement commonly included in web pages. A banner ad typically has a fixed location and size on a page. Each time the page is transmitted, received and displayed on a user's client device, a banner ad may appear in the same location, though the content of the ad or the content of the page may differ. Depending on the advertising terms, an advertiser may pay for the ad based on the number of times the number of times users click on the ad. Advertisers desire to increase the number of users who click on an ad having a corresponding hyperlink, since this indicates that the user has actually viewed the ad, and provides an opportunity to bring the user to a page on the advertiser's web site and present more information

Advertisers and web site owners desire ways to induce users to pay attention to advertisements. Animated advertisements have been used as one way to grab attention. Since users may become used to animated advertisements, they may become less effective over time.

Web sites and advertisers benefit by finding ways to increase user interest in advertising content, including the amount of time users spend viewing ads, the number of ads viewed, the user actions resulting from ads, as well as revenue generated by advertising. Thus, it is with respect to these considerations, and others, that the present invention was made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Descriptions, which is to be read in association with the accompanying drawings, wherein:

FIG. 1 shows a functional block diagram illustrating an environment for practicing the invention;

FIG. 2 shows one embodiment of a network device that may be employed;

FIG. 3A shows a pictorial representation of a web page with an advertisement prior to expansion, in accordance with an embodiment of the invention;

FIG. 3B shows a pictorial representation of a web page with an expanded advertisement framework, in accordance with an embodiment of the invention;

FIG. 4 illustrates a flow diagram generally showing an embodiment of a process for interacting with an advertisement framework; and

FIG. 5 illustrates a flow diagram generally showing an embodiment of a process for providing and facilitating an advertisement framework.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly, the present invention is directed towards a method, apparatus, and system for providing and interacting with a framework that facilitates presenting, viewing, and manipulating advertising content. An initial advertisement, image, or other content may be transmitted to a user along with program instructions and other content. In response to a user action, the initial advertisement may be expanded or replaced with an expanded advertisement framework that includes advertising content and a set of one or more controls. A user may manipulate the controls to view additional advertising content. The user may also interact with any one or more of the advertisements displayed in a display area of the framework.

The set of controls included in the advertisement framework may include one or more of a next control, a previous control, a submit control, or a close control. A user may manipulate the next control to display a new advertisement in the framework. The user may manipulate the previous control to display a previously displayed advertisement in the framework. An advertisement may include a form in which the user can enter information. The user may manipulate the submit control to cause entered information to be transmitted to a server. The set of advertisements may include forms, coupons, or other types of advertisements.

Mechanisms of the invention may include transmission of user commands and user-entered information from the client device to a forms server. The forms server may store this information, analyze or aggregate it, or forward it to an advertiser or information repository.

Mechanisms of the invention may include determining the set of advertisements to be displayed in the framework based on one or more factors, including demographics of the user, the manipulation of controls by the user, or other information associated with the user.

Mechanisms of the invention may include closing the advertisement framework when the user manipulates a pointer to be outside of the bounding area of the framework. In one embodiment, closing the framework is selectively performed, based on whether the user has entered information in a form of a currently displayed advertisement in the framework.

Although the embodiments are described within in terms of an Internet architecture, the invention is not so limited. For example, various embodiments may also employ a variety of other types of networks or communication mechanisms, or physical storage media, without departing from the scope of the invention.

### Illustrative Environment

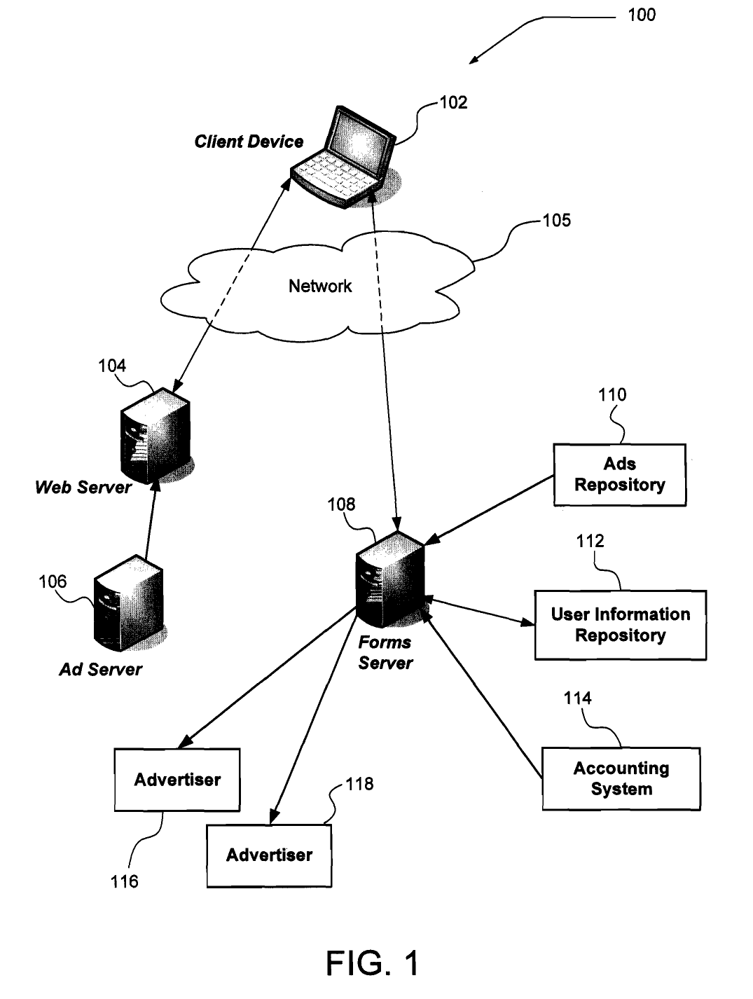

FIG. 1 is a functional block diagram illustrating an exemplary operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes a client device 102, a web server 104, an ad server 106, a forms server 108, and network 105. Operating environment 100 further includes an ads repository 110, a user information repository (UIR) 112, an accounting system 114, and one or more advertisers 116-118. Client device 102 is in communication with web server 104, which is in communication with ad server 106. Client device 102 is also in communication with forms server 108, which is in communication with ads repository 110, UIR 112, accounting system 114, and advertisers 116-118. In one embodiment, accounting system 114 may be in communication with advertisers 116-118.

Client device 102 may include virtually any computing device capable of receiving and sending a message over a network, such as network 105, to and from another computing device. The set of such devices described in an exemplary embodiment below generally includes mobile devices that are usually considered more specialized devices with limited capabilities and typically connect using a wireless communications medium such as cell phones, smart phones, pagers, radio frequency (RF) devices, infrared (IR) devices, CBs, integrated devices combining one or more of the preceding devices, or virtually any mobile device, and the like. However, the set of such devices may also include devices that are usually considered more general purpose devices and typically connect using a wired communications medium at one or more fixed location such as laptop computers, personal computers, multiprocessor systems, microprocessor-based or programmable consumer electronics, network PCs, and the like. Similarly, client device 102 may be any device that is capable of connecting using a wired or wireless communication medium such as a personal digital assistant (PDA), POCKET PC, wearable computer, and any other device that is equipped to communicate over a wired and/or wireless communication medium.

Each client device 102 may include an application that enables a user to perform various operations. For example, each client device may include one or more messenger applications that enables the client device to send and receive messages to/from another computing device employing various communication mechanisms, including, but not limited to Short Message Service (SMS), Multimedia Messaging Service (MMS), Instant Messaging (IM), internet relay chat (IRC), Mardam-Bey's internet relay chat (mIRC), Jabber, email, and the like.

Client device 102 may be further configured with a browser application that is configured to receive and to send content in a variety of forms, including, but not limited to markup pages, web-based messages, audio files, graphical files, file downloads, applets, scripts, text, and the like. The browser application may display content, such as markup pages, or web pages, that it receives. As used herein, the term “page” refers to markup pages, web pages, text documents, or other content that may be displayed in a browser or similar application. When a user interacts with a browser application by using a keyboard, pointer device, verbal commands, or other input mechanism, the browser application may respond by performing actions such as requesting a new web page or other content, sending information to a server, displaying additional information or playing audio data, or the like. The browser application, can for example, detect when and where a pointer device is moved within a displayed page, when and where a mouse click or other mouse input is made, and other types of user actions. The browser application may be configured to receive and display graphics, text, multimedia, and the like, employing virtually any network protocol or markup based language, including, but not limited to a Handheld Device Markup Language (HDML), such as Wireless Markup Language (WML), WMLScript, JavaScript, and the like, Standard Generalized Markup Language (SGML), HyperText Markup Language (HTML), Extensible Markup Language (XML).

Network 105 is configured to couple client device 102, with other network devices, such as web server 104 and forms server 108. Though not illustrated in FIG. 1, communication between other devices or systems, such as web server 104, ad server 106, forms server 108, ads repository 110, UIR 112, accounting system 114, and advertisers 116-118, as well as other devices not illustrated, may employ network 105 alone or in combination with other communication mechanisms. Any of these components may also communicate with each other without employing network 105. The discussion of network 105 is therefore applicable to communication between any network components illustrated or described herein.

Network 105 is enabled to employ any form of computer readable media for communicating information from one electronic device to another. In one embodiment, network 105 is the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G) generation radio access for cellular systems, Wireless-LAN, Wireless Router (WR) mesh, and the like. Access technologies such as 2G, 3G, and future access networks may enable wide area coverage for network devices, such as client device 102, and the like, with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link. In essence, network 105 includes any communication method by which information may travel between client device 102, web server 104, ad server 106, forms server 108, ads repository 110, UIR 112, accounting system 114, or advertisers 116-118.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

Web server 104 may include program logic that performs actions that maintain a Web site or a portion thereof. Such actions may include generating and transmitting Web pages, text, graphic, media, or binary files, prompting a user for information, receiving user information, processing information received from a user, and the like. Web server 104 may include storage for content to be transmitted to client devices, and/or receive content from other network components such as ad server 106. Web server 104 may communicate with clients using any one or more communication protocols or languages, as described above, such as HTTP, HTML, WAP, WML, XML, and the like. Web server 104 may transmit instructions in the form of scripting languages or other instruction languages.

Devices that may operate as a web server 104 include, but are not limited to personal computers, desktop computers, multiprocessor systems, microprocessor-based or programmable consumer electronics, network PCs, servers, network appliances, and the like.

FIG. 1 illustrates an ad server 106, in communication with web server 104. Briefly, an ad server provides advertisements, which may be banner ads, application ads, such as search ads, or other types of advertisements. An application advertisement is an advertisement that is associated with an interaction with an application. It is typically integrated with the application presentation in some way. A search ad is an example of an application ad. When a search is performed, a search application may select one or more ads based on the keywords of the search. The search application may combine search ads with the search results, and present them in an integrated manner. In some embodiments, the integration may be so complete that there is not a clear distinction between the search ads and the search results. In some embodiments, one or more ways of indicating the search ads may be included, such as text, color, line separators, and the like. Similarly, other applications may generate application ads. A mapping application, for example, may use the location specification in a request to generate advertisements based on the location, such as those of businesses in the area, and may display an advertisement on the map.

A banner advertisement typically is placed in a location that is separate from, or more distinguishable from, an application's results. For example, it may be at the top or bottom of a page, or along the margin. A banner advertisement may be selected based on criteria similar to those for an application ad, based on different criteria, or randomly selected

Ad server 106 may have an associated advertisement database (not shown), which may be integrated or in communication with ad server 106. An advertisement database stores data pertaining to advertisement contents, constraints, and rules pertaining to the use of each advertisement.

Devices that may operate as ad server 106 include, but are not limited to personal computers, desktop computers, multiprocessor systems, microprocessor-based or programmable consumer electronics, network PCs, servers, network appliances, and the like.

Forms server 108 may be considered to be a specific type of web server, serving and receiving content related to advertisements and an application framework. Forms server 108 may include program logic that performs actions that facilitate communication with client 102, storage, retrieval, or generation of data for sending to client 102, receipt of data from client 102, or determination of data to send to client 102. Forms server 108 may include storage for content to be transmitted to client devices, and/or receive content from other network components such as ads repository 110, UIR 112, accounting system 114, and advertisers 116-118. Forms server 110 may communicate with clients using any one or more communication protocols or languages, as described above with respect to web server 104, such as HTTP, HTML, WAP, WML, XML, and the like. Forms server 108 may transmit instructions in the form of scripting languages or other instruction languages. Devices that may operate as a forms server 108 include, but are not limited to personal computers, desktop computers, multiprocessor systems, microprocessor-based or programmable consumer electronics, network PCs, servers, network appliances, and the like.

Forms server 108 may receive a request from client device 102 for content to be displayed on client device 102, such as a web page or a portion thereof. In response, forms server 108 may apply program logic to determine content to send to the client device. This logic may make a determination based on one or more of a number of factors, including but not limited to user demographics, user interests, prior user actions, and other user information. For example, forms server 108 may send a first advertisement or form to the client device 102 for display, and then receive a subsequent command from the client device. In response to receiving a command to display a “next” advertisement, the forms server may send a new advertisement to the client device. In response to receiving a command to display a “previous” advertisement, the forms server may send an advertisement previously sent to the client device. In response to receiving a “submit” command along with user-entered information, the forms server may store the user information or forward it to one or more other components, and send a new advertisement back to the client device. This logic is described in further detail below.

In response to receiving user data or commands, the forms server 108 may send data to one or more advertisers 116-118 associated with the current advertisement. The data sent to the advertiser may include at least a portion of the information received from the client device. The data may also include additional information associated with the client device or the user of the client device, which may be retrieved by the forms server from its storage or from other components.

In response to receiving user data or commands, the forms server 108 may send data to the accounting system 114. This data may include data identifying the current advertisement, the user actions, context information such as time of day, user demographics, or other information.

In response to receiving user data or commands, the forms server 108 may send data to the user information repository 112. This data may include data entered by the user at the client device, and may be stored in a manner that allows retrieval of demographic or identifying information of the user. Logic and actions of the forms server 108 are described in additional detail herein.

Ads repository 110 may store and provide content to forms server 108. This content may include any one or more of forms, advertisements, coupons, text, graphics, audio, or video. Ads repository 110 may store data pertaining to advertising contents, constraints, and rules pertaining to the use of each advertisement or other content. For example, constraints may include information specifying dates or time periods during which an ad is to be used, geographic restrictions, demographic restrictions, quantitative limits, and the like.

User information repository (UIR) 112 may store and provide data associated with each user of a client device 102. This information may include information such as name, address, email address, and the like. The information may include a variety of demographic information such as age, gender, geographic location, education level, job type, income level, home ownership, and the like. The information may also include personal preferences or interests, such as interest in movies, sports, theater, restaurants, and the like. Some of the information may be information obtained from user actions, such as advertisements that the user interacted with, web pages viewed, purchases, and the like. As described herein, some of this information may be used to determine advertisements to present to a user, or the ordering of advertisements.

Accounting system 114 may store and report on aggregate actions of users. This may include, for each advertisement or each advertiser, the number of users that viewed an advertisement, the number of users that entered information in a form, the number of users that printed or saved a coupon, or other actions that indicate user interest or disinterest in content associated with an advertiser. The accounting system 114 may facilitate reporting data used in determining revenue from each advertiser.

Advertisers 116-118 represent entities that sponsor advertisements to be presented to users at client devices such as client device 102. Advertisers may send content to the forms server to be displayed. They may also send rules, constraints, or other information indicative of preferences for displaying each advertisement. These may include constraints on time periods for displaying an advertisement, demographic preferences for an advertisement, limits on the number of times to employ an advertisement, and other such data. Advertisers may receive, from the forms server, reports on the use and feedback associated with each advertisement. They may receive data entered by each user in an associated form. They may also receive reports of aggregate data relating to the use of associated advertisements.

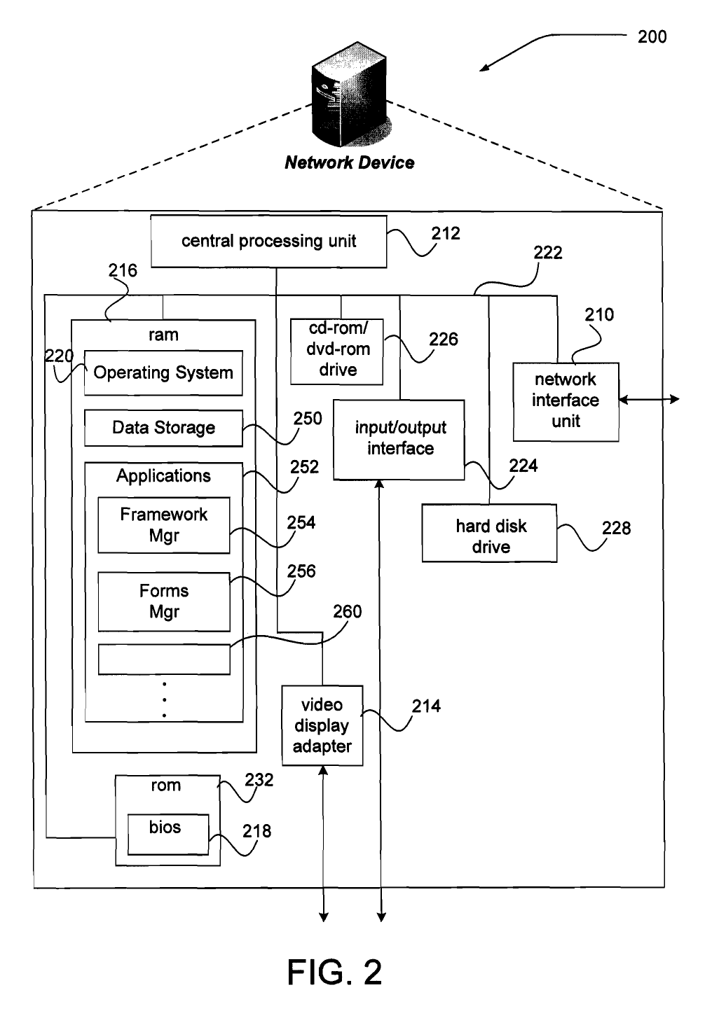

Each of the components described above, specifically, the forms server 108, ads repository 110, UIR 112, accounting system 114, and advertisers 116-118 may include one or more of a computing device, a storage device, or a communication mechanism. Each of these components may include, but are not limited to personal computers, desktop computers, multiprocessor systems, microprocessor-based or programmable consumer electronics, network PCs, servers, network appliances, and the like. Each component may communicate over network 105, another network having technology as described for network 105, or another communications mechanism. Each of these components may include network device 200 of FIG. 2, or a portion thereof.

Although forms server 108 and other components of FIG. 1 are illustrated as distinct network devices, the invention is not so limited. For example, a single network device may be configured to perform the operational aspects of forms server 108 and web server 104, or even a plurality of network devices may be configured such that the operational aspects of forms server 108 and/or web server 104 are distributed over the plurality of network devices. Similarly, any portion or all of the operational aspects of forms server 108, ads repository 110, UIR 112, ad server 106, or accounting system 114 may be combined in one or more devices or distributed among two or more devices in a variety of configurations.

### Illustrative Server Environment

FIG. 2 shows one embodiment of a network device, according to one embodiment of the invention. Network device 200 may include many more or less components than those shown. For example, network device 200 may operate as a network appliance without a display screen. The components shown, however, are sufficient to disclose an illustrative embodiment for practicing the invention. Network device 200 may, for example, represent forms server 108 of FIG. 1. Network device 200 may represent web server 104, ads repository 110, UIR 112, ad server 106, or advertisers 116-118.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, network interface card (NIC), or the like.

Network device 200 may also include an SMTP handler application for transmitting and receiving email. Network device 200 may also include an HTTP handler application for receiving and handing HTTP requests, and an HTTPS handler application for handling secure connections. The HTTPS handler application may initiate communication with an external application in a secure fashion.

Network device 200 also may include input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 is utilized by network device 200 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more data storage components 250 may include program code or data used by the operating system 220 or by applications 252. Data may be stored in ram 216 or other storage devices, such as hard disk drive 228. One or more applications 252 are loaded into mass memory and run on operating system 220. Examples of application programs include email programs, schedulers, calendars, transcoders, database programs, word processing programs, spreadsheet programs, security programs, web servers, and so forth. Mass storage may further include applications such as framework manager 254 and forms manager 256.

Framework manager 254 is configured to send instructions or data for displaying and manipulating an advertisement framework to the client device 102. Framework manager 254 may receive commands from a client device relating to navigation within the advertisement framework, closing of the framework, and entering of user data, or other commands. In response to these commands, framework manager 254 may communicate with forms manager 256 to retrieve additional content, store or forward user information, or perform other actions.

Forms manager 256 is configured to perform actions relating to an advertisement or form. This may include responding to a user selecting a “submit” button or otherwise indicating that information has been entered. Forms manager 256 may receive user-entered information and send information to UIR 112 for storage or other processing. Forms manager may send information relating to user actions to accounting system 114. These actions may indicate one or more actions that trigger fees to be billed. Actions may include lead generation, submitting user information, printing or downloading a coupon, initiating a purchase, or the like. Forms manager may also send information to one or more advertisers 116-118 in response to user actions. This information may include user-entered data, user actions, or other information that may be desired by an advertiser.

Though framework manager 254 and forms manager 256 are represented as separate applications executing on network device 200, the invention is not so limited. The representation may be a logical representation, and the logic and configuration of frames manager 254 and forms manager 256 may be combined in one application or distributed in multiple applications, or on multiple devices in a variety of ways. Unless clearly stated otherwise, each of framework manager 254 and forms manager 256 are to be considered as logical operative units as described herein.

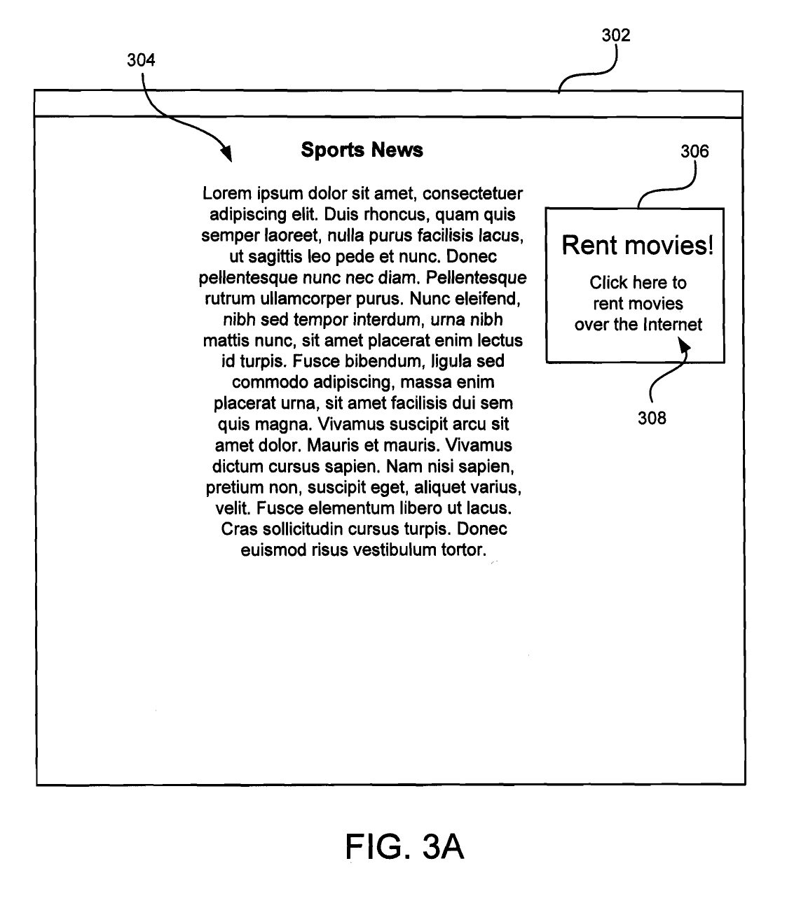

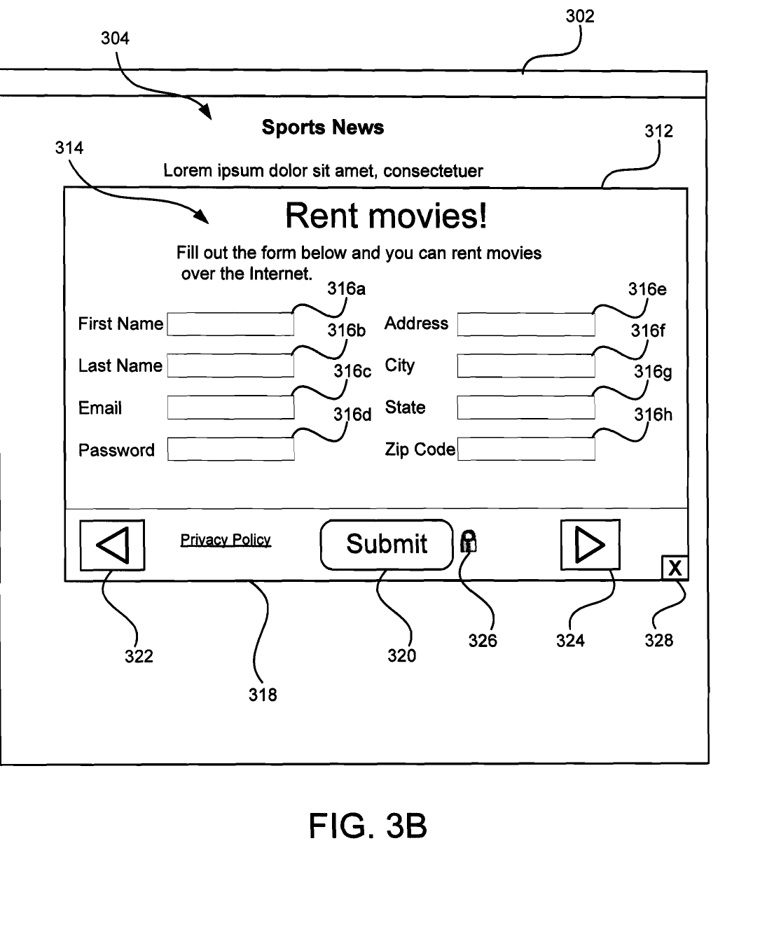

FIG. 3A shows a pictorial representation of a web page 302. Web page 302 includes various content 304, which may include any of a variety of text, graphics, animation, video, or other content commonly available on web pages. Web page 302 also includes an initial advertisement 306, containing advertising content 308. Advertising content 308 may include text, graphics, animation, video, or other types of content. Advertisements may come in a variety of sizes and shapes. Advertisement 306 is depicted as having a rectangular shape and a size that is a small portion of web page 302, and a small portion of a display screen at a typical screen resolution.

FIG. 3B shows a pictorial representation of web page 302 with an expanded advertisement framework 312, in accordance with an embodiment of the invention. The expanded advertisement framework 312 may be displayed in response to a user performing an action such as selecting initial advertisement 306 of FIG. 3A. The action of selecting an advertisement may be performed by moving a pointer within the boundaries of the advertisement. This is referred to as a mouse-over or rollover. A selection may also be made by pressing a keyboard key, speaking an oral command, touching a touch screen, or any other selection technique.

In one embodiment, in response to a selection of initial advertisement 306, instructions that are associated with web page 302 perform actions to display the advertisement framework 312. The instructions may be part of a scripting language such as JavaScript or another computer language. In one embodiment, JavaScript and dynamic HTML are used to perform at least some of the actions on the client device described herein.

As illustrated in FIG. 3B, advertisement framework 312 has a rectangular shape and is a larger size than corresponding initial advertisement 306. The area of advertisement framework 312 may, for example, be approximately two, four, or ten times the area of advertisement 306, or even larger. In one embodiment, when advertisement framework 312 is displayed, the page content 304 remains unchanged in size and relative position on web page 302, though some of the content may appear to be covered by at least a portion of framework 312. This is illustrated in FIG. 3B. In one embodiment (not shown), at least some of the content 304 may be resized or moved to accommodate the display of framework 312. In one embodiment, at least some of the content 304 may that remains visible may be modified to reduce its visual impact, such as by modifying color of text or background to reduce contrast.

FIG. 3B illustrates an advertisement framework 312 having a control section 318 along a border of the framework. Advertisement framework 312 also includes advertising content 314 within the boundaries of the framework. As illustrated, advertising content 314 includes a combination of text and a form. The form includes text input boxes 316a-316h and corresponding labels. The labels indicate “first name,” “last name,” “email,” “password,” “address,” “city,” “state,” and “zip code,” respectively. Advertisement 314 may include graphics, animation, or other web content. In one embodiment, audio may be played while an advertisement is displayed.

A coupon is another type of advertisement that may be displayed within advertisement framework 312. A user may print or download a coupon and subsequently use the coupon to obtain a product or service discount, a free product or service, admission to an event, and the like.

Control section 318 may include one or more controls that may be manipulated by a user. As illustrated, a “previous” button 322 and a “next” button 324 may be used to view the previously viewed advertisement or the next advertisement, respectively. By using the previous button or the next button, a user may view multiple advertisements sequentially, and return to an advertisement that was previously displayed. In one embodiment, selecting one or more keyboard keys, such as the right arrow key and left arrow key cause the same actions as the next button 324 and the previous button 322, respectively.

A “submit” button 320 may be selected by a user to indicate that information entered in a form is to be submitted. Actions taken when information is submitted may vary, and may depend on the particular form. For some forms, in response to selecting “submit,” information entered by the user is sent to a corresponding advertiser. This information with respect to each user may be referred to as a “lead,” and the process of receiving this information may be referred to as “lead generation.” For some forms, in response to selecting “submit,” information entered by the user is stored or used by the forms server. For example, a form may allow a user to specify types of advertisements that are desired during the present session or in the future. This feedback may be used to determine subsequent advertisements to present. In one embodiment, in response to selection of the submit button 320, a follow-up message may be displayed. For example, a follow-up message may include text such as “Thank You,” a graphic, audio, or another message. In one embodiment, in response to selecting the submit button 320, in addition to submitting information, a new advertisement may be retrieved and displayed within the application framework, in a manner similar to a selection of the next button.

It is to be noted that, though FIG. 3B and the above text describe a previous button 322, a next button, 324, and a submit button, 320, controls used to invoke the previous, next, and submit commands may be any type of control.

Control section 318 may also include a security indicator 326, represented by a lock graphic. A security indicator may indicate that encryption is used during communication to protect the privacy of the user. In one embodiment, the Secure Sockets Layer (SSL) or TLS protocol is used to communicate information and provide security. Control section 318 may also include a “close” button 328. In response to a selection of the close button 328, associated instructions may close or hide the advertisement framework 312 and redisplay the initial advertisement 306, or another advertisement in the location of initial advertisement 306. Though some implementations may distinguish closing or opening the framework from hiding or revealing the framework, respectively, from a visual point of view, closing and hiding appear similar or the same. As used herein, closing the framework includes hiding the framework, and opening the framework includes revealing the framework, unless clearly stated otherwise.

In one embodiment, in response to a user moving a pointer outside of the area of the advertisement framework, mechanisms of the invention close or hide the advertisement framework in a manner similar to selection of the close button 328. In one embodiment, moving a pointer outside of the advertisement framework may close or hide the advertisement framework unless the user has entered information in a currently displayed form, in order to avoid losing information. The user may be required to take further action, such as selecting the close button 328 in order to close or hide the application framework. In one embodiment, closing the browser window, or navigating to a new web page causes the application framework to close. In one embodiment, selecting one or more keyboard keys, such as the escape key, causes the same action as selecting the close button 328.

Though the advertisement framework 312 illustrates a single contiguous control section 318, the invention is not so limited. An advertisement framework may include multiple control sections or a control section that is not a single contiguous unit. In one embodiment, a control section may be disconnected from the advertisement 314.

The advertisement framework 312, as illustrated and described, and variations thereof as described herein, enable a user of a client device to view a variety of advertisements, selecting ones that are of interest, and skipping over ones that are not of interest. The user may enter information in any one or more forms to take advantage of advertiser offers, request additional information, or provide information for other reasons. This provides a user with control over various advertising.

### Generalized Operation

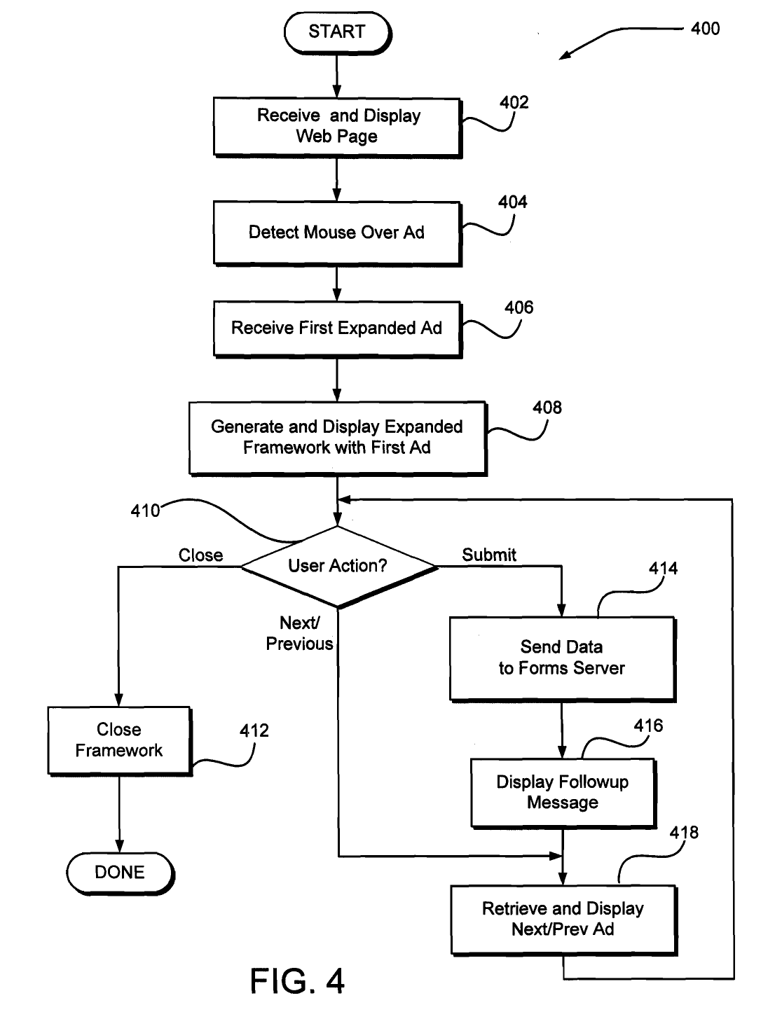

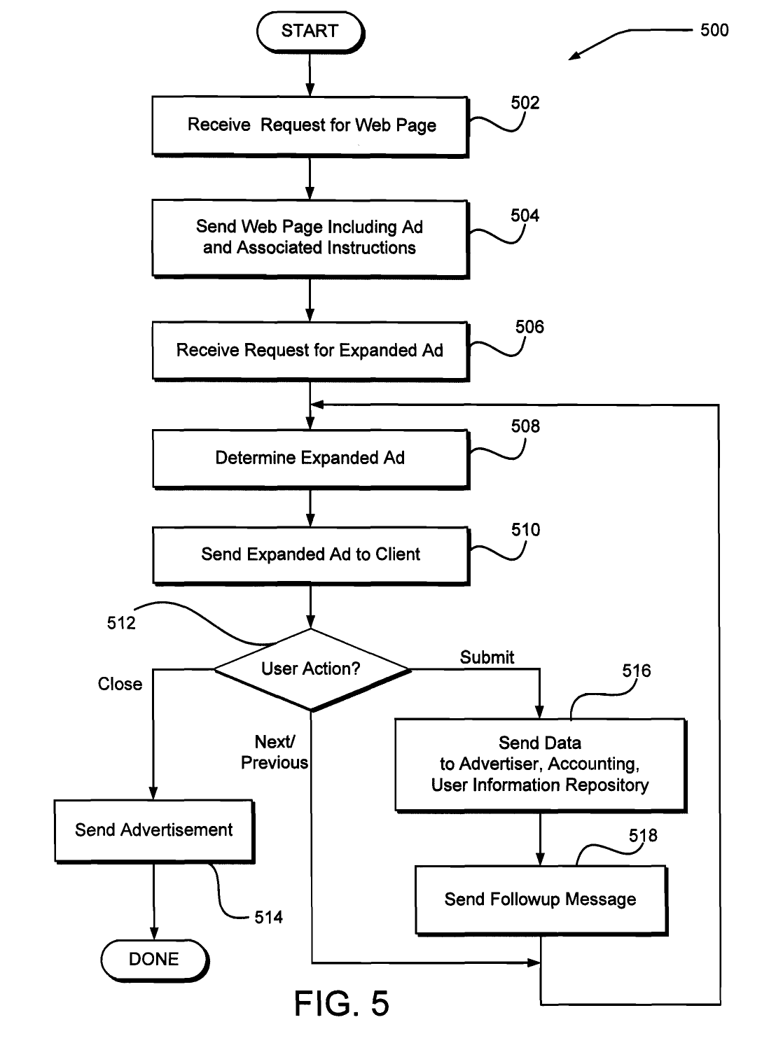

The operation of certain aspects of the invention will now be described with respect to FIGS. 4-5. FIG. 4 illustrates a flow diagram generally showing one embodiment of a process for interacting with an advertisement framework. Process 400 of FIG. 4 may be implemented within various components of a client device, such as client device 102 of FIG. 1. In the discussion that follows, reference to FIG. 3A or 3B are made to aid in illustrating an embodiment of a page and an advertisement framework in conjunction with the actions described.

Process 400 begins, after a start block, at block 402, where a client device receives and displays some content, such as a web page. The content may be displayed in a browser or other application. The content may include text, graphics, animation, video, computer instructions, scripts, or other types of content. In one embodiment, the content includes instructions of a scripting language such as JavaScript. In one embodiment, at least a portion of the content may be received from a web server such as web server 104 of FIG. 1. A portion of the content may have been previously received and stored in a cache on the client device. The content may include an advertisement, such as advertisement 306, graphic, text, or other type of content that is displayed. In the discussion that follows, any of these types of content are included in the term “advertisement.”

Processing then proceeds to block 404, where, if a user has selected an area of the advertisement, this event is detected. Selecting an area of the advertisement, herein referred to as “selecting the advertisement,” may be performed by moving a pointer within a bounding area of the advertisement. A pointer moved within a specified area may be referred to as a “mouse-over,” or a “rollover,” and the detected event is referred to as detecting a mouse-over or rollover of the advertisement. A mouse-over can be detected without requiring that a mouse button be pressed. The bordered region bounding the advertisement such that a rollover event is triggered or detected within the region is referred to as a “rollover region.” In one embodiment, a browser application detects the rollover event and invokes instructions, such as JavaScript instructions, that are associated with the rollover event.

Processing continues next to block 406, where, in response to the detection of the mouse-over event and the invocation of the associated instructions, a first expanded advertisement is received. In one embodiment, in response to detecting the mouse-over event at block 404, the client device requests and receives content corresponding to the expanded advertisement. In one embodiment, this content may be received from the forms server 108 of FIG. 1. The expanded advertisement may include one or more of a form, a coupon, text graphics, or another type of content. In one embodiment, at least a portion of the expanded advertisement is included in the content that was received by the client device at block 402, and the actions of step 406 may be combined into block 402.

Processing continues next to block 408, where, further in response to the detection of the mouse-over event and the invocation of the associated instructions, an advertisement framework is displayed. FIG. 3B illustrates an example of an advertisement framework 312, and associated text herein describe embodiments of such a framework. The advertisement framework 312 may include the expanded advertisement. Though the actions illustrated in FIG. 4 are not limited to the sequence illustrated, one variation in particular is now noted. In one embodiment, at least some of the actions of block 408 are performed prior to, or concurrently with, actions of block 406. That is, an advertisement framework may be displayed prior to, or concurrently with, retrieving a first expanded advertisement.

Processing continues next to decision block 410, where a user navigation action is performed, and a determination is made as to the type of action. It is to be noted that other types of user actions may be performed, though they are not illustrated in FIG. 4. For example, a user may enter information in an advertisement form. This may include entering text, making selections in web controls such as checkboxes or radio buttons, and the like. The decision block 410, as illustrated, determines a user action to be one of three types of actions, as follows.

If a user has performed an action to close the advertisement framework, processing may proceed to block 412, where the advertisement framework is closed or hidden, while the currently displayed page remains visible. The user's view may return to the initial advertisement that was displayed prior to display of the framework, such as advertisement 306 of FIG. 3. Alternatively, a new advertisement may be displayed in the space formerly used to display the initial advertisement. The advertisement displayed in this space may be received from the web server 104 or the forms server 108 of FIG. 1, or may be retrieved from a storage on the client device.

The action to close the advertisement framework may be selecting the close button 328, moving the pointer outside of the advertisement framework 312, pressing a keyboard key such as the escape key, performing an oral command, or another action. As noted above, in one embodiment, moving a pointer outside of the framework when the user has entered information in a currently displayed form may not cause the framework to close. Though not illustrated in FIG. 4, a non-closure of the framework following a pointer movement outside of the framework may return the process flow back to the decision block 410, where a next action is analyzed.

Following the action of block 412, process flows to a “done” block, where the process 400 may return to a calling process.

If, at the decision block 410, it is determined that a next or previous navigation command has been detected, the process may proceed to block 418, where a next or a previous advertisement, respectively, is retrieved and displayed. In one embodiment, the next or previous advertisement may be retrieved from the forms server 108. In one embodiment, if the next or previous advertisement is cached on the client device, the advertisement is retrieved from the client device cache. The actions of repeatedly invoking a next command or a submit command in order to display a plurality of advertisements may be referred to as “scrolling through” advertisements. In one embodiment, Asynchronouse JavaScript and XML (AJAX) calls may be used to retrieve a new advertisement and display it within the advertisement framework 312, while remaining on the same web page 302.

If, at the decision block 410, it is determined that a “submit” command has been detected, such as by a user selection of the submit button 320, the process may flow to block 414, where information entered in a current form is sent to a server, such as the forms server 108. Entering information in a current form may be performed by any one or more of a number of techniques. This may include entering text, making selections in web controls such as checkboxes, radio buttons, manipulating slider controls, and the like.

In one embodiment, actions to at least partially validate the entered information may be performed. For example, required fields may be checked to determine whether information has been entered, syntax may be validated, or other types of validation may be performed. Notifications to the user may result in the process flowing back to block 410 without completing the actions of blocks 414 and 416.

After the actions of block 414, the process may flow to block 416, where a follow-up message may be displayed, such as “Thank You,” or another message. In one embodiment, an audio follow-up message is played. The process may then flow to block 418, where a next advertisement is retrieved and displayed. Though not illustrated in FIG. 4, a request for the next message may be sent from the client device to the forms server, in order to elicit the next advertisement.

After the actions of block 418, the process may loop back to decision block 410, where a next user action is analyzed. In one embodiment, if, at the decision block 410, it is determined that a next or previous command has been entered, and a current form has been filled out, the process proceeds as for the actions of a submit command. That is, the actions of blocks 414, 416, and 418 may be performed.

Though not illustrated in FIG. 3B or FIG. 4, additional types of controls may be presented in the control section 318. For example, a control representing a command to “show more like this” may result in the mechanisms of the system retrieving and displaying additional advertisements having characteristics similar to the currently displayed advertisement. This may be a similar product or service, the same advertiser, or products or services in the same field as the current one.

FIG. 5 illustrates a flow diagram generally showing one embodiment of a process 500 for providing and facilitating an advertisement framework. Process 500 of FIG. 5 may be implemented within various components of one or more server devices, such as web server 104 or forms server 108 of FIG. 1, or a combination thereof.

Process 500 begins, after a start block, at block 502, where a request for content, such as a web page, is received. In one embodiment, the request may be received within the HTTP protocol, though other protocols may be employed in accordance with the invention.

Processing may continue at block 504, where, in response to receiving the request, content such as a web page is sent. The content may include an initial advertisement, such as advertisement 306. The content may also include instructions associated with the web page and with the advertisement. The instructions may include logic to handle selection of the advertisement, display of an advertisement framework, and interaction with the advertisement framework. The actions of block 504 correspond to the actions of block 402 of FIG. 4, where the web page is received and displayed by a client device.

Processing may continue at block 506, where a request is received for an expanded advertisement. In response, processing may flow to block 508, where an expanded advertisement is sent to the requesting device. This action corresponds to, and is in response to, the actions of block 404, where a mouse-over is detected on the client device.

Processing may continue at block 508, where a determination is made of an expanded advertisement to send to the client device. This action may include retrieval of data, rules, or constraints from one or more sources and employing a logic to determine the advertisement. The data may include demographic or other information corresponding to the user or the client device. Some of this information may include a user's geographic location, age, gender, education, personal or professional interests, prior actions, prior purchases, and the like. In one embodiment, at least a portion of this information may be stored in and retrieved from a storage component such as user information repository 112 of FIG. 1.

Some data, rules, or constraints that are used in determining an expanded advertisement may correspond to the set of available ads. This may include date or time constraints corresponding to an ad, limits on frequency or cumulative use of an ad or set of ads, geographic or other demographic constraints on use of an ad, and the like. In one embodiment, at least a portion of this information may be stored in and retrieved from a storage component such as the ads repository 110 of FIG. 1. In one embodiment, a set of ads recently viewed by a user or on a client device may be considered when determining an advertisement. A user's decisions as to whether to skip over an ad, go back to view a previously viewed ad, enter information in an ad, print or download a coupon, and other such user actions may be considered when determining advertisements to send to the user. An ordering of the ads may also be determined based on the user information and user actions to present the most relevant ads or the ads that the user may find to have the highest interest are presented before other ads. In one embodiment, a user's actions during one or more sessions with the advertisement framework may be stored and used in subsequent sessions to determine the set of ads or the ordering of ads to present to the user. The number of advertisements viewed in one session may be used to determine the set of ads to present in a later session with the user.

Processing may continue at block 510, where a determined expanded ad may be sent to the client device. This action may correspond to the actions of block 408 of FIG. 4, where the ad is received by the client, when the expanded ad is the first ad of a session in an advertisement framework. The action may correspond to the actions of block 418, where the ad is received by the client, for subsequent ads.

Process 500 may then wait for a response or command from the client device. Processing may continue at decision block 512, where a determination is made of the type of user action that has been performed, based on the data received from the client. The decision block 512 corresponds to the decision block 410 of FIG. 4, and each decision may be made in response to a command or action by a user. If the user has performed an action to close the advertisement framework, the process may flow to block 514, where an advertisement is sent to the client. This may be the initial ad that was sent in block 504 or another ad to be displayed outside of the advertisement framework. In some sequences of actions, process 500 may not send an ad in response to a close action. Processing may then flow to a done block, and return to a calling process.

If, at the decision block 512, it is determined that a next or previous command has been invoked, the process may loop back to block 508, where a determination is made of an expanded ad to send. This action may employ at least some of the factors and logic as described above relating to block 508. In response to a “previous” command, the process may simply determine the prior expanded ad that was sent to the client, and determine to send the same ad. Similarly, in response to a “next” command following a “previous” command, the process may simply determine a previously sent ad based on the sequence of ads that had been sent to the client, in order to maintain the appropriate sequence. In one embodiment, not illustrated in FIG. 5, in response to a “next” command that has been selected after filling in a form, the process continues at block 516, in the same or similar sequence as for a “submit” command, as discussed herein.

If, at the decision block 512, it is determined that a “submit” command has been invoked, the process may continue at block 516, where data may be sent to one or more destinations for storage or processing. As stated in the discussion accompanying FIG. 4 and elsewhere herein, a user may enter a submit command after entering data in a form, such as the form illustrated in FIG. 3B. The user-entered data may be sent to the forms server when the submit command is invoked. Other data may also be sent to the forms server, including the client IP address, user identification data or other data stored in a cookie on the client device, an identification of the current expanded advertisement, an identification of the currently displayed web page, or the like. Any of this data may be sent to various components. For example, any one or more of the data entered on the form, the client IP address, a client user ID, or other data corresponding to the user may be sent to an advertiser corresponding to the expanded advertisement. A user identification and an identification of the current advertisement may be sent to an accounting system, in order to track cumulative leads or interest in each advertisement. In one embodiment, data representing an instance of interest in an advertisement is sent to the accounting system, without sending specific user identification. Information entered by the user or other information associated with the user may be sent to a user information repository, for storage, reporting, or analysis. Data pertaining to the number of times an ad is viewed or for which information is submitted may be sent to an ads repository for storage, reporting, analysis, or to be used as a factor in subsequent determinations of expanded ads to display. In one embodiment, user actions of viewing an advertisement trigger a first level of fees paid by an advertiser, and user actions of submitting information trigger a second, higher level of fees paid by the advertiser. Thus, for a specific ad, the system may track a number of user views and a number of user information submission, and bill an advertiser based on these amounts.

In some embodiments, information entered by users, or various information received as part of the processes 400 and 500 are stored by the forms server or a related component, and sent to one or more components after a number have been accumulated. For example, a report may be sent to an advertiser on a daily or weekly basis rather than, or in addition to, sending data after each ad is displayed or each time a submit command is invoked. Similarly, a report may be sent to the accounting system or UIR periodically, with information pertaining to multiple ads or multiple users.

Processing may continue at block 518, where a follow-up message may be sent to the client device. As discussed herein, a follow-up message may include text, graphics, and the like. In one embodiment, a follow-up message may be specific to an advertisement, set of advertisements, or an advertiser corresponding to the advertisement. In one embodiment, a follow-up message is a generic message. In one embodiment, a follow-up message is displayed by instructions on the client device without being sent by the forms server in response to a submit command.

Processing may then loop back to block 508, where a determination is made of another expanded ad to send, as described above, and the expanded ad may be sent to the client device.

Though not illustrated in FIG. 5, some embodiments may include other controls or commands. An advertisement framework may include a “print” control for printing a coupon, form, or other content. A “download” control or command may be available for downloading a coupon, form, document, file, or other content. Information representing invocation of any of these, or other commands, may be sent to the forms server, and stored or forwarded to other components in a manner similar to that described herein.

It will be understood that each block of the flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for enabling interaction with a plurality of advertisements, comprising:
enabling a page having an initial content with a corresponding rollover region to be displayed on a client computing device;
in response to a user selection of the initial content, enabling an advertisement framework to be displayed on the same page on the client computing device, the advertisement framework having a display area and including a first advertisement and at least two controls including a next control and a submit control;
in response to a user selection of the next control, enabling a second advertisement to be displayed on the client computing device within the advertisement framework; and
in response to a user selection of the submit control, retrieving user data entered by the user in the first advertisement, and storing or forwarding the user data.

2. The method of claim 1, wherein the at least one control includes a previous control, the method comprising in response to a user selection of the previous control, enabling a previously displayed advertisement to be displayed on the client computing device within the advertisement framework.

3. The method of claim 1, further comprising determining the plurality of advertisements at least partly based on information associated with the user.

4. The method of claim 1, further comprising determining the plurality of advertisements at least partly based on information submitted by the user in at least one of the plurality of advertisements.

5. The method of claim 1, further comprising selectively closing the advertisement framework based on whether a pointer moves outside of the advertisement framework display area and whether the user has entered information in the first advertisement.

6. The method of claim 1, further comprising billing an advertiser based on a number of times users view the first or second advertisement and a number of times users submit information in the first or second advertisement.

7. A server comprising:
a memory for storing logical instructions;
a processor for executing the logical instructions stored in the memory, the execution of the logical instructions causing actions to be performed, including:
sending, to the client computing device, client logical instructions to perform the method of claim 1; and
in response to a request to send a previous advertisement, sending to the client computing device an advertisement previously sent to the client computing device.

8. A system for providing a plurality of advertisements, including a first advertisement and at least one additional advertisement, to a user of a client device, the system comprising at least one server, the at least one server comprising:
a memory for storing logical instructions;
a processor for executing the logical instructions stored in the memory, the execution of the logical instructions causing actions to be performed, including:
enabling the client device to display a page having an initial content;
enabling the client device to, in response to a user selection of the initial content, display an advertisement framework on the same page, the advertisement framework including the first advertisement and a plurality of controls for selecting the at least one additional advertisement to be displayed in place of the first advertisement and for submitting information entered by the user within at least one of the plurality of advertisements to the at least one server;
receiving the submitted information; and
storing or forwarding the submitted information.

9. The system of claim 8, wherein the plurality of controls includes a next control and a previous control to provide a user with commands for viewing new advertisements of the plurality of advertisements and advertisements previously viewed by the user of the plurality of advertisements within the application framework.

10. The system of claim 8, the actions further comprising determining at least one advertisement of the plurality of advertisements at least partly based on demographic data associated with the user of the client device.

11. The system of claim 8, the actions further comprising determining at least one advertisement of the plurality of advertisements at least partly based on commands received from the user by operation of at least one of the plurality of controls.

12. The system of claim 8, wherein the advertisement framework display area is greater than an area enclosing the initial content.

13. The system of claim 8, wherein the plurality of advertisements comprises a plurality of forms and at least one coupon.

14. A processor readable storage medium having computer-executable instructions, wherein the execution of the computer-executable instructions provides for enabling a user of a client device to control viewing of a plurality of advertisements by enabling actions, including:
in response to a first user action on a web page, displaying an advertisement framework on the web page, the advertisement framework including a first advertisement of the plurality of advertisements and a set of controls; and
in response to a user manipulation of the set of controls, displaying another advertisement of the plurality of advertisements in the advertisement framework on the web page and transmitting user-entered information from the client device to a server.

15. The processor readable storage medium of claim 14, the actions further including in response to a user manipulation of the set of controls, displaying a previously viewed advertisement of the plurality of advertisements in the advertisement framework.

16. The processor readable storage medium of claim 14, the actions further including determining at least a portion of the plurality of advertisements at least partly based on whether the user has entered information in a previously viewed advertisement of the plurality of advertisements.

17. The processor readable storage medium of claim 14, the actions further including determining an ordering of the plurality of advertisements at least partly based on demographics associated with the user.

18. The processor readable storage medium of claim 14, wherein the display of the advertisement framework hides a portion of the web page containing initial content, the actions further including in response to a user invocation of a close command, closing the advertisement framework and redisplaying the initial content within the portion of the web page.

19. The processor readable storage medium of claim 14, the actions further including providing to the user an interface for scrolling through the plurality of advertisements, each advertisement of the plurality of advertisements being displayed within the advertisement framework on the web page.

20. The processor readable storage medium of claim 14, wherein the web page includes an initial content, the initial content has a corresponding rollover region, the first user action includes movement of a pointer within the rollover region, and the advertisement framework has a corresponding display area at least twice the area of the initial content rollover region.
